(19) United States
(12) Patent Application Publication
(10) Pub. No.: US 2018/0045366 A1
(43) Pub. Date: Feb. 15, 2018

(54) Screwless bow holder for archery hunting

(71) Applicant: Gregory Perez, Waco, TX (US)

(72) Inventor: Gregory Perez, Waco, TX (US)

(21) Appl. No.: 15/655,413

(22) Filed: Jul. 20, 2017

Related U.S. Application Data
(60) Provisional application No. 62/374,248, filed on Aug. 12, 2016.

(51) Int. Cl. F16M 13/02; A01M 31/00; F16B 2/18; F16B 2/08

(52) U.S. Cl. CPC F16M 13/022; F16B 2/08; A01M 31/00; F16B 2/185

(57) ABSTRACT

A screwless bow or rifle support for the attachment to objects in a hunting environment such as trees without the need for screws or other bore holes.

### CROSS-REFERENCE TO RELATED APPLICATIONS

Ser. No. 62/374,248

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of camping and hunting accessories. More particularly, the present invention is in the technical field of hanging devices suitable for non-destructive attachment to trees through the use of a strap and support plate.

The marketplace has several solutions for supporting the weight of a hunting bow or rifle with a holding device attached to a support member, usually a tree because of their prevalence in the hunting environment. Many designs are on the market and some have been patented such as Archery Bow Support U.S. Pat. No. 5,482,241A, and Hunting Bow Hanger U.S. Pat. No. 5,967,475. The prevailing problem with the designs presently available is that they predominantly rely on putting screws into the tree. Screwing in the holder is a destructive process that damages the tree and not suitable for all situations or desired by the landowner or allowed on public lands. Further, this means of attachment is more time consuming, usually requiring tools, likely to produce undesirable noise in the natural environment (and also thus scaring desirable wildlife) Such an attachment is also less adjustable without additional pivoting mechanical parts as it would require unscrewing and device, moving it, and screwing it in again to a new location.

### SUMMARY OF THE INVENTION

The present invention overcomes the problems of destructive screwed-in holding devices and their non-adjustability through the use of multiple novel features. Firstly, rather than use screws drilled into a tree the screwless bow holder utilizes an adjustable strap. By foregoing screws and using a strap the boring of holes into a tree is no longer required. The holder may be removed and moved quickly any number of times non-destructively. Hunters will frequently leave their holders screwed into trees for the next hunting trip due to the labor involved, however with a screwed-in holder (even if permitted) this is an option not available in instances where public land restrictions or leased property prohibit the leaving of equipment, additionally the equipment is subject to the elements and theft. Further, in using a strap other alternatives of support become available other than tree trunks and limbs as the strap can surround and be secured to a multitude of objects including, if one desired, an ATV, a metal post, a rock, an automobile, or other natural feature or object that one would not typically desire or be able to bore holes into to secure such a holder.

Secondly, the holding rod has a base that is able to circulate giving 360 degrees of adjustability once strapped to the support. As the rod is round it is a simple matter to rotate the rod once bisected through the strap. The advantage herein is that the holder can be attached to a non-vertical support member (including to a horizontal member) such as a tree limb or branch and the holder is easy to rotate to the desired orientation to hold one's hunting implement. Optionally, the rod, particularly the terminal end, may have coatings or flanges to increase friction and stabilization of the hunting implement held, further the end may be threaded to allow attachment of screw-on accessories.

The base member of the rod holds the rod against the support structure by the constrictive force of the attachment straps. Having a base of between 5 to 10 centimeters in diameter is sufficient to distribute the downward force asserted by the holding rod and hunting implement while maintaining adjustability for rotation. The base member need not be round, however it is a preferred shape as it is easy to rotate having a fixed base surface area and without edges that could potentially cut into the support member or get caught on outcroppings, particularly with vegetation. Optionally, the base member may have friction assistive coatings to facilitate its attachment to prevent sliding, or alternatively padding materials attached if desired for a particular application to prevent scratching for example if secured to a painted surface.

### BRIEF DESCRIPTION OF THE DRAWINGS

FIG. 1 is a perspective view of the screwless bow holder attached to a tree

FIG. 2 is a top down view of the screwless bow holder attached in the same configuration with the tree

### DETAILED DESCRIPTION OF THE INVENTION

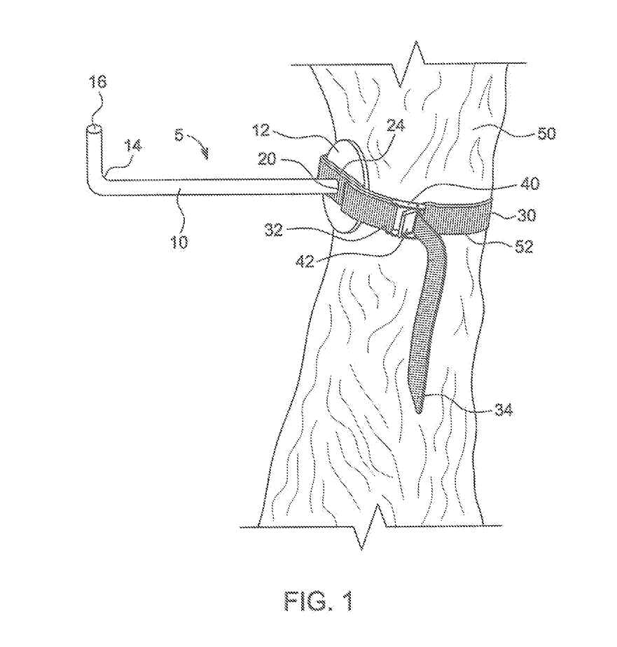

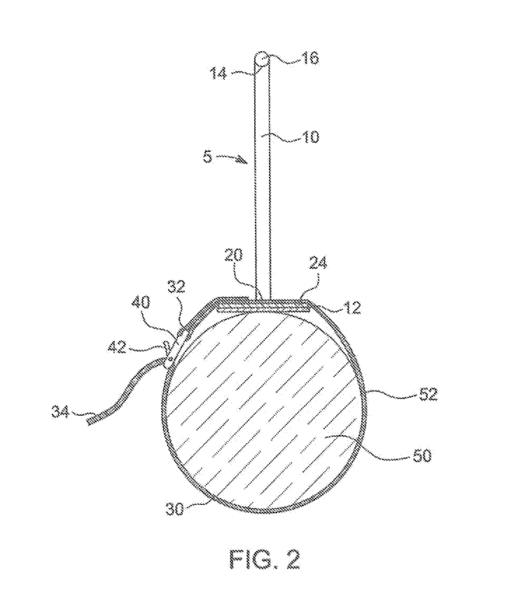

Referring to FIGS. 1 and 2 the bow holder 5 is secured to a support member 50, in this depiction a tree. A strap 30 made from a sufficiently flexible and weather resistant material such as nylon applies a constrictive force fixing the holder 12 against the support 50 along the strap's ventral edge 52. There are numerous means to buckle 40 the strap including slides, common buckles, spring buckles or cam buckles. A spring loaded cam buckle 40 is a preferred means as it is quickly adjustable by the user and as depicted in FIGS. 1 and 2. Such a buckle 40 can be easily secured by looping the strap 30 through the buckle loop 32 and securing the strap 30 back against itself by sewing or other attachment mechanisms. The opposite adjustable end strap 34 is fed through the buckle 40 and secured by the spring loaded mechanism 42 of the buckle 40.

A rigid plate 24 is permanently attached to the ventral side of strap 30 in the section that fits across the bow holder 5's base member 12. This base member 12 and the strap 30 have a pre-cut point of bisection 20 through which the perpendicular rod 10 passes giving the strap 30 sufficient strength to support the weight of the holder 5 and equipment attached thereon without the strap 30 fraying, twisting, or ripping.

A perpendicular rod 10 made from a rigid material such as iron is attached to a base member 12 which sits flush against the support member 50 such as a tree or post found in hunting environments. The perpendicular rod 10 is bent at angle at hook 14 to prevent the bow from sliding off the holder 5.

The rod 10 and base member 12 may be rotated 360 degrees through the strap bisection 20 allowing the holder 5 to be strapped at a multitude of angles depending on the types of support member 50 available in the environment, which will be highly variable in nature, and be adjusted to a useful configuration to support the hunting implement. Rod 10 may be any number of optional lengths, but a typical useful length of 20-30 cm. Longer rod 10 lengths would require scaling up the other components including a larger base member 12 to distribute and support the downward forces asserted by the leverage of a longer rod 10.

Manufacture of the holder 5 portion can be done in a multitude of fashions. Rod 10 can be screwed into base member 12, welded thereon, or rod 10 and base member 12 could be fashioned, forged, or molded out of the same piece of material. Iron is an inexpensive, strong material that lends itself well for manufacture of these parts, however many other metals and sufficiently strong non-metal materials may be substituted in place of iron. For example, aluminum, while slightly more expensive, is an alternate material with adequate strength while also having corrosion resistance.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A system for supporting hunting or camping equipment in the natural environment through use of a strap surrounding a support member including a tree trunk or limb and said strap being secured by a spring loaded cam buckle where the strap has a rigid plate permanently affixed and bisected by a rigid rod with an end flange and with a support base fitting between the rigid plate and the support member and the plate and rod are able to rotate 360 degrees where the combination of the pressure of the strap and rigid plate on the support base allow the rigid rod to be used to hold items supported off the ground including bows, rifles, backpacks for them to be hung safely off the ground or for support and stabilization of hunting equipment during their use, all being non-destructive to the support member as it is removable and reusable without the use of boring holes.

2. A system for supporting an archery bow from a fixed object comprising
a base member in direct contact with a supporting object,
a strap member of sufficient length to encircle the supporting object,
a rigid plate support member attached to said strap,
a rod member perpendicular to the base member that bisects said strap and the rigid plate support member,
an adjustable cam lever attached to one end of the strap member such that the opposite end of the strap member can encircle the fixed supporting object then slip through the grasping portion of the cam lever and be gripped at adjustable lengths.

3. The system in claim 2 where the supporting object is a tree.

4. The system in claim 2 where the rod member is coated with a non-slip coating.

5. The system in claim 2 where the terminus of the rod member opposite the base member is bent at an angle of 30 to 90 degrees.

6. The system in claim 2 where the terminus of the rod member opposite the base member is threaded to receive screw on attachments.

7. The system of claim 2 where the rod bisecting the strap and rigid plate support member can be rotated 360 degrees.

8. A system for supporting an archery bow from a fixed object comprising
a base member that is rotatable 360 degrees and in direct contact with a supporting object that is a tree,
a strap member of sufficient length to encircle the supporting object,
a rigid plate support member attached to said strap,
a rod member coated in a non-slip coating perpendicular to the base member that bisects said strap and the rigid plate support member and the rod member is bent 30 to 90 degrees at its terminal end,
an adjustable cam lever attached to one end of the strap member such that the opposite end of the strap member can encircle the fixed supporting object then slip through the grasping portion of the cam lever and be gripped at adjustable length.
